(19) United States
(12) Patent Application Publication
(10) Pub. No.: US 2006/0270798 A1
(43) Pub. Date: Nov. 30, 2006

(54) Composition comprising a polymer matrix and a functionalized additive and items made from said composition

(76) Inventors: Franck Touraud, Vernon (FR); Florence Clement, Yzeron (FR); Jean-Paul Michalson, Lyon (FR); Sandrine Rochat, Villeurbanne (FR); Valerie Garrier, Lyon (FR)

Correspondence Address: Jean Louis Seugnet;Rhodia Inc CN 7500, Intellectual Property Department, 259 Prospect Plains Road, Cranbury, NJ, 08512-7500, US

(21) Appl. No.: 10/545,379

(22) PCT Filed: Feb. 13, 2004
(86) PCT No.: PCT/FR04/00328

§ 371 Date: Jul. 20, 2006

(30) Foreign Application Priority Data
Feb. 14, 2003 (FR) 03/01795

(51) Int. Cl. C08L 77/00

(52) U.S. Cl. 525/178

(57) ABSTRACT

The invention relates to a composition comprising at least one polymer matrix and a functionalised additive, obtained by the reaction of a mixture of compounds including at least one multifunctional compound and a functionalised monofunctional compound. Said composition particularly permits the production of threads, fibres, films, filaments, and moulded items.

The present invention relates to a composition comprising at least one polymer matrix and at least one functionalized additive obtained by the reaction of a mixture of compounds comprising at least one polyfunctional compound and at least one functionalized monofunctional compound. The composition according to the invention makes it possible in particular to manufacture yarns, fibers, films, filaments and molded articles.

### PRIOR ART

Polymers are raw materials that can be converted by transfer molding, injection molding, injection-blow molding, extrusion, extrusion/blow molding or spinning, especially into numerous articles such as, for example, body parts, which are blow-molded, extruded or transfer molded, yarns, fibers or films.

There are at least two major constraints in all these polymer conversion processes.

The first of these constraints is that the thermoplastic polymers used have to be characterized, in the melt state, by a viscosity or a rheological behavior compatible with the abovementioned forming processes. This is because such thermoplastic polymers, when they are in the melt, have to be fluid enough to be able to be easily and rapidly conveyed and handled in certain forming machines.

The other constraint that weighs on thermoplastic polymer compositions is associated with the mechanical properties that they must have after having been melted, formed and hardened by cooling. In particular, these mechanical properties are the impact strength, the flexural or tensile modulus, the flexural or tensile strength, among others. Moreover, it is common practice, in order to improve the mechanical properties of thermoplastic polymers, to add reinforcing fillers to them, for example mineral, glass or carbon fillers, in order to form composite materials.

One of the technical problems arising when faced with these two constraints is that they are a priori conflicting. This is because, to reduce the melt viscosity, it is well known to select thermoplastic polymers having low molecular weights. However, this rheological advantage is to the detriment of the mechanical properties of the polymer when formed and hardened.

To try to correct this, it is also common practice to incorporate, into thermoplastic polymer matrices, various additives suitable for modifying their melt rheology. These additives are all the more useful when the polymers contain reinforcing fillers.

The dilemma that arises with these additives is that they have to be both inert or nonreactive with the matrix, in order not to cause profound changes to the chemical structure, for example crosslinking, while still being able to be dispersed in this matrix in order to provide it with the required functionalities, and to do so uniformly.

However, the first requirement, of nonreactivity, would have more of a tendency to employ additives that are not compatible with the matrix, whereas the second requirement, of dispersibility, would encourage a person skilled in the art to use instead additives having a structure compatible with that of the matrix.

Moreover, rheology-modifying additives must be capable of improving the capability of the thermoplastic polymer to be compression molded, injection molded or extruded.

There is consequently a need to develop additives that are capable of modifying the rheological behavior of thermoplastic matrices and enable the mechanical properties to be maintained. It is also desirable to have additives capable of being able to modify the hydrophobicity and/or hydrophilicity of a polymer matrix without compromising the rheology and the mechanical properties of the compositions.

International Application WO 02/066716 relates to a process for manufacturing polyamide yarns and fibers, consisting in melt blending a linear polyamide with a star-type polyamide. The copolyamide obtained makes it possible to improve the yield in the spinning process and to avoid breakages.

International Application WO 03/002668 relates to the preparation of a star polyamide functionalized by a polyalkylene oxide block and its addition to a polyamide matrix so as to improve the hydrophilicity and antistatic behavior of the composition obtained.

However, the additives used do not allow a good compromise to be achieved between the rheology, the mechanical properties, the hydrophilicity and hydrophobicity.

Invention

The present invention relates to functionalized additives, including chain stopper compounds. These functionalized additives are incorporated into a polymer matrix, especially so as to modify the rheological behavior, the hydrophilicity and/or the hydrophobicity of said matrix.

One of the essential objectives of the present invention is to propose an additive that modifies the rheological behavior, the hydrophilicity and/or the hydrophobicity of the polymer matrix, preferably a thermoplastic matrix, without compromising the mechanical properties, and in particular the impact strength, of said formed and hardened matrix.

Preferably, these additives do not react with the polymer matrix, advantageously made of a polyamide, that is to say they are not capable of modifying the chemical structure on the polymer matrix, which would for example result in a reduction in the molecular weight of the matrix.

The composition according to the invention has a melt flow index suitable for transfer molding and injection molding operations, for example allowing complete filling of a mold. The composition according to the invention is thus suitable for various melt-forming techniques, namely injection molding, injection-blow molding, extrusion-blow molding, film forming, extrusion and spinning, and also having a high mechanical strength and possibly good transparency due to low crystallinity.

This polymer composition possesses the melt rheology and mechanical properties required in the industry for conversion of these polymers, without the incorporation of additives, carried out in order to improve these properties, being excessively expensive and disturbing the other properties of the polymer.

### FIGURES

FIG. 1 shows the setup used for visualizing the capillary imbibition of water into a yarn, in which (1) represents the yarn being tested and (2) represents a bath containing water and a dye.

FIG. 2a shows the start of the experiment, when the yarn is dipped into the colored solution.

FIG. 2b shows the capillary rise during the experiment.

### DETAILED SUMMARY OF THE INVENTION

The present invention relates to a composition comprising at least one polymer matrix and at least one additive, said additive being obtained by the reaction of a blend of compounds, which consists of:

a) a polyfunctional compound of formula (I):
R¹-Xₙ (I)

b) optionally, a difunctional monomer of formula (II) or the corresponding cyclic form:
X—R²—Y (II)

c) a monofunctional compound of formula (III):
R³—Y (III)
in which:
R¹ represents a hydrocarbon radical and/or silicone;
R² represents a hydrocarbon radical;
X and Y are antagonistic reactive functional groups capable of reacting together to form a covalent bond;
n is between 3 and 50, preferably between 3 and 15, particularly between 3 and 10 and more particularly between 3 and 4; and
R³ represents an aliphatic, cycloaliphatic and/or aromatic hydrocarbon radical and/or a silicone radical, it being possible for said radical R³ to comprise one or more heteroatoms, with the exception of polyalkylene oxides.

The radical R¹ may be a silicone radical and/or an aliphatic, cycloaliphatic and/or aromatic hydrocarbon radical, which may be substituted or unsubstituted, linear or branched, and unsaturated or saturated. It may contain 2 to 100, preferably 5 to 20, carbon atoms. It may also include one or more heteroatoms chosen from the group formed by: nitrogen, phosphorus, fluorine, oxygen, silicon and sulfur.

Preferably, the R¹ radical is either a cycloaliphatic radical, such as the tetravalent cyclohexanonyl radical, or a 1,1,1-propanetriyl or 1,2,3-propanetriyl radical. Mention may be made, as other R¹ radicals suitable for the invention, by way of example, of substituted or unsubstituted trivalent phenyl and cyclohexanyl radicals, tetravalent diaminopolymethylene radicals with a number of methylene groups advantageously of between 2 and 12, such as the radical originating from EDTA (ethylenediaminetetraacetic acid), octavalent cyclohexanonyl or cyclohexadinonyl radicals, and radicals originating from compounds resulting from the reaction of polyols, such as glycol, pentaerythritol, sorbitol or mannitol, with acrylonitrile.

Preferably, Y is an amine functional group when X represents a carboxylic functional group, or Y is a carboxylic functional group when X represents an amine functional group. The reactive functional groups X and Y are thus capable of forming an amide functional group.

Y may also be an alcohol functional group when X represents a carboxylic acid functional group or carboxylic acid derivative, or Y is a carboxylic acid functional group or carboxylic acid derivative when X represents an alcohol functional group. The reactive functional groups X and Y are thus capable of forming an ester functional group.

Mention may be made, as examples of polyfunctional compounds of formula (I), of 2,2,6,6-tetra(β-carboxyethyl)cyclohexanone, diaminopropane-N,N,N′,N′-tetraacetic acid of following formula: 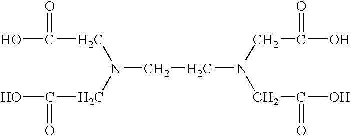
or the compounds originating from the reaction of trimethylolpropane or glycerol with propylene oxide and amination of the terminal hydroxyl groups. The latter compounds are sold under the trade name Jeffamine T® by Huntsman and have as general formula: 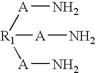
in which:
R₁ represents a 1,1,1-propanetriyl or 1,2,3-propanetriyl radical,
A represents a polyoxyethylene radical.

It is also possible to use Jeffamine T403® (polyoxypropylene triamine) from Huntsman as polyfunctional compound according to the invention.

Examples of polyfunctional compounds that may be suitable are mentioned in particular in document U.S. Pat. No. 5,346,984, in document U.S. Pat. No. 5,959,069, in document Application WO 9635739 and in document EP 672703.

Mention is made more particularly of nitrilotrialkylamines, in particular nitrilotriethylamine, dialkylenetriamines, in particular diethylenetriamine, trialkylenetetramines and tetraalkylenepentamines, the alkylene preferably being ethylene, and 4-aminoethyl-1,8-octanediamine.

Mention is also made of the polyfunctional compounds exhibiting 3 to 10 carboxylic acid groups, preferably 3 or 4 carboxylic acid groups. Preference is given, among these, to the compounds exhibiting an aromatic and/or heterocyclic ring, for example benzyl, naphthyl, anthracenyl, biphenyl and triphenyl radicals, or heterocycles, such as pyridine, bipyridine, pyrrole, indole, furan, thiophene, purine, quinoline, phenanthrene, porphyrin, phthalocyanine and naphthalocyanine. Preference is very particularly given to 3,5,3′,5′-biphenyltetracarboxylic acid, acids derived from phthalocyanine and from naphthalocyanine, 3,5,3′,5′-biphenyltetracarboxylic acid, 1,3,5,7-naphthalenetetracarboxylic acid, 2,4,6-pyridine-tricarboxylic acid, 3,5,3′,5′-bipyridyltetracarboxylic acid, 3,5,3′,5′-benzophenonetetracarboxylic acid, 1,3,6,8-acridinetetracarboxylic acid, more particularly still trimesic acid and 1,2,4,5-benzenetetracarboxylic acid.

Mention is also made of polyfunctional compounds, the core of which is a heterocycle exhibiting a point of symmetry, such as 1,3,5-triazines, 1,4-diazines, melamine, compounds derived from 2,3,5,6-tetraethylpiperazine, 1,4-piperazines or tetra-thiafulvalenes. Mention is more particularly made of 2,4,6-tri(aminocaproic acid)-1,3,5-triazine (TACT).

Thus, the polyfunctional compound of formula (I) is preferably chosen from the group comprising: 2,2,6,6-tetra(β-carboxyethyl)cyclohexanone, diaminopropane-N,N,N′,N′-tetraacetic acid, nitrilotrialkylamines, trialkylenetetramines and tetraalkylenepentamines, 4-aminoethyl-1,8-octanediamine, 3,5,3′,5′-biphenyltetracarboxylic acid, acids derived from phthalocyanine, and from naphthalocyanine, 3,5,3′,5′-biphenyltetracarboxylic acid, 1,3,5,7-naphthalene-tetracarboxylic acid, 2,4,6-pyridinetricarboxylic acid, 3,5,3′,5′-bipyridyltetracarboxylic acid, 3,5,3′,5′-benzophenonetetracarboxylic acid, 1,3,6,8-acridine-tetracarboxylic acid, trimesic acid, 1,2,4,5-benzenetetracarboxylic acid, 1,3,5-triazines, 1,4-diazines, melamine, compounds derived from 2,3,5,6-tetraethylpiperazine, 1,4-piperazines, tetrathiafulvalenes, 2,4,6-tri(aminocaproic acid)1,3,5-triazine (TACT), polyalkylene oxides and/or mixtures thereof.

The radical R² may be an aliphatic, cycloaliphatic and/or aromatic hydrocarbon radical, which may be substituted or unsubstituted, linear or branched, unsaturated or saturated. It may contain 2 to 100, preferably 5 to 20 carbon atoms. It may also include one or more heteroatoms chosen from the group formed by: nitrogen, phosphorus, fluorine, oxygen, silicon and sulfur.

The difunctional monomer of formula (II) is preferably chosen from the group comprising: ε-caprolactam and/or the corresponding amino acid, aminocaproic acid, p-aminobenzoic acid or m-aminobenzoic acid, 11-amino-undecanoic acid, lauryllactam and/or the corresponding amino acid, 12-aminododecanoic acid, caprolactone, 6-hydroxy hexanoic acid, and oligomers and mixtures thereof. These oligomers generally have a degree of polymerization varying from 2 to 15.

The radical R³ may be a silicone radical and/or an aliphatic, cycloaliphatic and/or aromatic hydrocarbon radical, which may be substituted or unsubstituted, linear or branched, unsaturated or saturated. It may include one or more heteroatoms chosen from the group comprising: nitrogen, phosphorus, fluorine, oxygen, silicon and sulfur. Preferably, the radical R³ contains 1 to 100, particularly 5 to 30, carbon atoms. As mentioned above, the radical R³ does not include a group of the polyalkylene oxide type.

Preferably, the radical R³ does not include reactive functional groups X and/or Y capable of reacting with the functional groups X and/or Y of the polyfunctional compounds of formula (I) and of the difunctional monomers of formula (II).

The monofunctional “chain stopper” compound of formula (III) is preferably chosen from the group comprising: a monoacid or monoamine aliphatic compound, such as n-hexadecylamine, n-octadecylamine and n-dodecylamine; a monoamine or monoacid aromatic compound, such as benzylamine; a monoamine or monoacid silicone oil, such as polydimethylsiloxane monopropylamine; a monoamine or monocarboxylic acid organophosphorus compound, such as aminomethylphosphonic acid, a monoamine or monocarboxylic acid organosulfone compound, such as sulfanilic acid and sulfobenzoic acid; a monoamine or monocarboxylic acid quaternary ammonium compound, such as betaine; and/or mixtures thereof.

According to the present invention, the following may be blended together during the reaction: one or more different polyfunctional compounds of formula (I); no, one or more different difunctional monomers of formula (II); and one or more different monofunctional compounds of formula (III), depending on the desired properties.

The expression “overall degree of polymerization” is understood to mean the number of difunctional monomers of formula (II) included in the functionalized additive, independently of their distribution over the various functionalized groups X of the polyfunctional compound of formula (I). Preferably, the functionalized additive possesses an overall degree of polymerization of between 0 and 200 (limits included), more preferably between 0 and 100, even more preferably between 0 and 60 and particularly between 0 and 40. Conventionally, the degree of polymerization per branch of the functionalized additive is between 0 and 20, preferably between 0 and 15 and particularly 0, 1, 2, 3, 4, 5 and/or 6.

In general, the functionalized additive possesses a molecular weight of between 500 and 20 000 g/mol, preferably between 1000 and 10 000 g/mol and particularly between 1000 and 5000 g/mol.

In general, during the reaction from 1 to 60% by weight of polyfunctional compound of formula (I), from 0 to 95% by weight of difunctional monomer of formula (II) and from 3 to 90% by weight of monofunctional compound of formula (III) are blended. Preferably, during the reaction, from 3 to 40% by weight of polyfunctional compound of formula (I), from 10 to 90% by weight of difunctional monomer of formula (II) and from 5 to 80% by weight of polyfunctional compound of formula (III) are blended. In particular, during the reaction, from 5 to 20% by weight of polyfunctional compound of formula (I), from 20 to 80% by weight of difunctional monomer of formula (II) and from 10 to 70% by weight of monofunctional compound of formula (III) are blended.

Preferably, the additive according to the invention generally has an acid or amine terminal group (TG) content, expressed in meq/kg, of between 0 and 100, preferably between 0 and 50 and even more preferably between 0 and 25.

Preferably, the composition according to the invention contains no functionalized additives that cause a reduction in the molecular weight of the polymer matrix of 20% or more compared with a control composition comprising the same polymer matrix but without the addition of the additive of the invention, the molecular weight being measured according to a defined protocol P. The details of the protocol P for measuring the molecular weight are given in the examples below. According to the invention, the functionalized additive therefore is advantageously characterized by an ability to modify the rheological behavior of a polymer matrix, without compromising its structural integrity, and in particular without consequently reducing its molecular weight. This means that the additive seems not to react with the matrix. According to the present invention, the molecular weight is defined as the maximum of the molecular weight distribution of the polymer matrix to which the functionalized additive has been added, in polystyrene equivalents, measured by GPC (gel permeation chromatography) with refractometric detection, as defined in the protocol P given in detail below.

The molecular weight is measured on the composition to be analyzed and on the control composition, these being extruded, solidified and optionally granulated.

The abovementioned protocol P for measuring the molecular weight of the matrix M in a composition to be analyzed and in a control composition, involves an extrusion, resulting in the production of extruded rods. The rods (cut up beforehand into granules) then undergo the actual molecular weight determination. This protocol P for measuring the molecular weight of the compositions according to the invention and the control compositions is the following:

1) Polymer matrix/functionalized additive compositions:

The polymer matrix, especially a polyamide matrix, and the functionalized additive are in ground or crushed form, as powder, flakes or granules, and are then preblended.

The blend is then introduced into a twin-screw extruder.

This blend is melted in the extruder at a temperature T about 30° C. above the melting point Tₘ of the polymer matrix.

The M/functionalized additive blend is thus homogenized for 5 minutes and rods are recovered at the exit of the extruder, which are then granulated. The actual molecular weight measurement is carried out on the granules by derivatization of the polyamide by trifluoroacetic anhydride, with respect to polystyrene standards. The detection technique used is refractrometry;

2) Polymatrix control compositions containing no functionalized additive:

For each given M/functionalized additive composition, the molecular weight of the same polymer matrix is measured on a composition comprising the polymer matrix but not the functionalized additive.

The method is carried out on polymer granules, especially polyamide granules obtained in the same manner as that indicated at point 1 above, except that the granules contain no functionalized additive.

The polymer matrix according to the invention preferably consists of at least one thermoplastic (co)polymer chosen from the group comprising: polyolefins, polyesters, polyalkylene oxides, polyoxy-alkylenes, polyhaloalkylenes, polyalkylene phthalates or polyalkylene terephthalates, polyphenyls or polyphenylenes), polyphenylene oxide or polyphenylene sulfide, polyvinyl acetates, polyvinyl alcohols, polyvinyl halides, polyvinylidene halides, nitrile polyvinyls, polyamides, polyimides, polycarbonates, polysiloxanes, acrylic or methacrylic acid polymers, polyacrylates or polymethacrylates, natural polymers such as cellulose and derivatives thereof, synthetic polymers such as synthetic elastomers, or thermoplastic copolymers containing at least one monomer identical to any one of the monomers included in the abovementioned polymers, and also copolymers and/or blends thereof.

Preferably, the matrix may consist of at least one of the following polymers or copolymers: polyacrylamide, polyacrylonitrile, polyacrylic acid, ethylene-acrylic acid copolymers, ethylene-vinyl alcohol copolymers, methyl methacrylate-styrene copolymers, ethylene-ethyl acrylate copolymers, methacrylate-butadiene-styrene copolymers (ABS) and polymers of the same family; polyolefins, such as low-density polyethylene, polypropylene, low-density chlorinated polyethylene, poly(4-methyl-1-pentene), polyethylene, polystyrene and polymers of the same family; ionomers; poly(epichlorohydrins); polyurethanes, such as polymerization products of diols, such as glycerol, trimethylolpropane, 1,2,6-hexanetriol, sorbitol, pentaerythritol, polyetherpolyols, polyesterpolyols and compounds of the same family, with polyisocyanates, such as 2,4-tolylene diisocyanate, 2,6-tolylene diisocyanate, 4,4′-diphenylmethane diisocyanate, 1,6-hexamethylene diisocyanate, 4,4′-dicyclohexylmethane diisocyanate and compounds of the same family; polysulfones, such as the products of reaction between a sodium salt of 2,2-bis(4-hydroxyphenyl)propane and 4,4′-dichloro-dipheryl sulfone; furan resins, such as poly(furan); cellulose ester plastics, such as cellulose acetate, cellulose acetate butyrate, cellulose propionate and polymers of the same family; silicones, such as poly(dimethylsiloxane), poly(dimethylsiloxane-co-phenylmethylsiloxane) and polymers of the same family; or blends of at least two of the above polymers.

The particularly preferred polymers for forming the polymer matrix are chosen from the group comprising: polypropylene, polyethylene terephthalate (PET), polybutylene terephthalate (PBT), polypropylene terephthalate (PPT), (meth)acrylate-butadiene-styrene copolymer (ABS), polyacetal (POM), polyamides, semiaromatic polyamides, such as polyphthalamide (AMODEL) or polyarylamide (IXEF), polypropylene oxide (PPO), polyvinyl chloride (PVC), as well as copolymers and/or blends thereof.

Preferably, the polymer matrix is a thermoplastic matrix.

Preferably the thermoplastic polymer or polymers is or are selected from the group of (co)polyamides comprising: nylon-6, nylon-6,6, nylon-4, nylon-11, nylon-12, nylon-4/6, nylon-6/10, nylon-6/12, nylon-6/36, nylon-12/12 and copolymers and blends thereof.

As other preferred polymers of the invention, mention may be made of semicrystalline or amorphous polyamides, such as aliphatic polyamides, semiaromatic polyamides and, more generally, linear polyamides obtained by polycondensation between an aliphatic or aromatic saturated diacid and an aliphatic or aliphatic saturated primary diamine, polyamides obtained by the condensation of a lactam or of an amino acid, or linear polyamides obtained by condensation of a blend of these various monomers. More precisely, these copolyamides may, for example, be polyhexamethyleneadipamide, polyphthalamides obtained from terephthalic acid and/or isophthalic acid, such as the polyamide sold under the brand name AMODEL, and copolyamides obtained from adipic acid, hexamethylenediamine and caprolactam.

According to one particular embodiment of the invention, the thermoplastic polymer(s) is(are) a nylon-6 of high molecular weight, the relative viscosity of which, measured at 25° C. and at a concentration of 0.01 g/ml in a 96% sulfuric acid solution, is greater than 3.5 and preferably greater than 3.8.

To improve the mechanical properties of the composition according to the invention, it may be advantageous to add to it at least one reinforcing and/or bulking filler chosen from the group comprising fibrous fillers, such as glass fibers, mineral fillers such as clays or kaolin, or reinforcing nanoparticles or those made of a thermosetting material, and powdered fillers such as talc.

The degree of reinforcing filler incorporation is in accordance with the standards in the field of composites. It may for example be a filler content of 1 to 90%, preferably 10 to 70% and more specifically between 30 and 60%.

The functionalized additives may furthermore be combined with other reinforcing additives, such as toughness modifiers, such as optionally grafted elastomers.

The composition according to the invention may also contain any other appropriate additives or adjuvants, for example bulking fillers (SiO₂), fire retardants, UV stabilizers, heat stabilizers, delustrants (TiO₂), lubricants, plasticizers, compounds used for catalysis in the synthesis of the polymer matrix, antioxidants, antistatic agents, pigments, dyes, molding aids or surfactants.

The present invention also relates to a process for manufacturing an additive, said additive being obtained by the reaction of a blend of compounds comprising at least the following: a polyfunctional compound of general formula (I); optionally, a difunctional monomer of general formula (II) or the corresponding cyclic form; and a monofunctional compound of general formula (III), in which: R¹ and R², X and Y, n and R³ are defined as above.

The compositions of the invention may be used as raw material in the field of technical plastics, for example for the production of molded articles, by injection molding or injection-blow molding, extruded articles, by conventional extrusion or by extrusion blow molding, or films.

The compositions according to the invention may also be formed by melt spinning into yarns, fibers or filaments.

Preferably, a functionalized star polyamide additive is used, this being introduced into a thermoplastic, preferably polyamide, matrix. To introduce the functionalized additive of the invention into the polymer matrix, any known method for introducing compounds into a matrix may be used.

A first method may consist in blending the additive into the molten matrix and optionally subjecting the blend to a high degree of shearing, for example in a twin-extruder, so as to produce good dispersion. Such an extruder is generally placed upstream of the means for forming the molten plastic (molding, spinning). According to a standard method of implementation, this blend is extruded in the form of rods that are then cut into granules. The molded parts are then produced by melting the granules produced above and feeding the composition in the melt state into transfer molding, injection molding or spinning devices.

For the manufacture of yarns, fibers and filaments, the composition obtained at the exit of the extruder is optionally fed directly into a spinning unit.

A second method may be that which consists in blending the functionalized additive with the monomers of the polymer matrix, before or during polymerization.

According to a variant, an additive concentrate in a polymer matrix, prepared for example according to one of the methods described above may be blended into the polymer matrix.

In general, from 0.1 to 20% by weight, preferably 1 to 15% by weight, particularly 1 to 10% by weight and more particularly between 3 and 6% by weight of functionalized additive according to the invention is added to the polymer matrix.

According to another of its aspects, the aim of the present invention is to produce articles obtained by forming, preferably by transfer molding, injection molding, injection-blow molding, extrusion, extrusion-blow molding or spinning, one of the compositions as defined above.

These articles may be yarns, fibers, films or filaments.

They may also be articles molded from the composition according to the invention and optionally reinforcing fibers, such as glass fibers.

The articles according to the invention may be obtained from several compositions according to the invention, such as those defined above. An article may also be obtained from a composition comprising several different additives according to the invention.

The subject of the invention is also the use as agent for modifying the rheological behavior, the hydrophilicity and/or the hydrophocibity of a polymer matrix of a functionalized additive as defined above.

The subject of the present invention is also the use as agent for modifying the rheological behavior of a polymer matrix of an additive of the invention as described above with R¹, R², X, Y and n as defined above and R³ representing an aliphatic, cycloaliphatic and/or aromatic hydrocarbon radical and/or a silicone radical, said radical R³ possibly including one or more heteroatoms.

The subject of the present invention is also the use as agent for modifying the hydrophobicity of a polymer matrix of an additive of the invention as described above with R¹, R², X, Y and n as defined above and R³ representing a hydrophobic aliphatic, cycloaliphatic and/or aromatic hydrocarbon radical and/or a silicone radical, it being possible for said radical R³ to comprise one or more heteroatoms. For example, it is possible to use a monofunctional “chain stopper” compound of formula (III) chosen from the group formed by: a monoacid or monoamine aliphatic compound, such as n-hexadecylamine, n-octadecylamine and n-dodecylamine; a monoamine or monoacid aromatic compound, such as benzylamine; a monoamine or monoacid silicone oil, such as polydimethylsiloxane monopropylamine; and/or blends thereof.

The subject of the present invention is also the use as agent for modifying the hydrophilicity of a polymer matrix of an additive of the invention as described above with R¹, R², X, Y and n as defined above and R³ representing a hydrophilic aliphatic, cycloaliphatic and/or aromatic hydrocarbon radical, it being possible for said radical R³ to comprise one or more heteroatoms and/or a phosphonic, phosphoric, sulfonic and/or quaternary ammonium functional group, with the exception of polyalkylene oxides. For example, it is possible to use a “chain stopper” monofunctional compound of formula (III) chosen from the group consisting of: a monoamine or monocarboxylic acid organophosphorus compound, such as aminomethylphosphonic acid; a monoamine or monocarboxylic acid organosulfone compound, such as sulfanilic acid and sulfobenzoic acid; a monoamine or monocarboxylic acid quaternary ammonium compound, such as betaine; and/or blends thereof.

A specific language has been used in the description so as to make it easier to understand the principle of the invention. However, it should be understood that no limitation to the scope of the invention is envisaged by the use of this specific language. Modifications, improvements and refinements may be envisaged by a person skilled in the art in question on the basis of his own general knowledge.

The term and/or includes the following meanings: and, or, and also any other possible combination of the elements connected with this term.

Further details and advantages of the invention will become more clearly apparent from the examples given below purely by way of indication.

### EXPERIMENTAL PART

### Example 1

The reaction was carried out in a 500 ml glass reactor commonly used in the laboratory for the melt synthesis of polyesters or polyamides. The following were introduced into the reactor: 238.1 g of octadecylamine (0.90 mol), 61.9 g of 1,3,5-benzenetricarboxylic acid (0.30 mol), 0.16 g of Ultranox® 236 from GE Specialty Chemicals and 0.29 g of a 50% (w/w) aqueous solution of hypophosphorous acid. The reactor was then swept with dry nitrogen.

The reaction mass was mechanically stirred at 50 rpm and gradually heated from 90° C. to 2500 over about 150 minutes. This temperature was then maintained until the end of the reaction. After maintaining these conditions for one hour, the system was gradually evacuated, to reach a pressure of 15 mbar in 10 minutes, and then maintained under vacuum for a further two hours thirty minutes. Finally, the reactor was cooled down to room temperature and opened, to recover about 280 g of star.

Differential thermal analysis (10° C./min) showed a melting peak at 58.4° C. Gel permeation chromotrography characterization (eluant: dichloromethane+2/1000 trifluoroacetic anhydride+0.005M tetrabutylammonium fluoroborate) showed a narrow peak corresponding to Mw=1450 g/mol and Mn=1300 g/mol (the weights being expressed relative to polystyrene standards).

### Example 2

The reaction was carried out in a 500 ml glass reactor as above. The following were introduced into the reactor preheated to 70° C.: 98.2 g of octadecylamine (0.37 mol), 96.3 g of ε-caprolactam (0.85 mol), 25.6 g of 1,3,5-benzene tricarboxylic acid (0.12 mol), 0.22 g of Ultranox® 236 and 0.40 g of a 50% (w/w) aqueous hypophosphorous acid solution. The reactor was then swept with dry nitrogen.

The reaction mass was mechanically stirred at 50 rpm and gradually heated from 70° C. to 250° C. in about 300 minutes. This temperature was then maintained until the end of the reaction. After maintaining these conditions for one hour, the system was progressively evacuated, reaching a pressure of 20 mbar in one hour, and then maintained under vacuum for a further one hour. Finally, the reactor was cooled down to room temperature and then opened, to recover about 200 g of star.

Differential thermal analysis (10° C./min) showed a melting peak at 51.4° C. Gel permeation chromatography characterization (eluant: dichloromethane+2/1000 trifluoroacetic anhydride+0.005M tetrabutylammonium fluoroborate) showed a narrow peak corresponding to Mw=2990 g/mol and Mn=2260 g/mol (the masses expressed relative to polystyrene standards). Terminal group assays showed a content of residual acid functional groups of 40.9 meq/kg and amine functional groups of 11.0 meq/kg. The degree of conversion was therefore around 97%. ¹H NMR (Bruker 300 MHz) of a solution in a 1/1 mixture by weight of deuterated trifluoroacetic acid and deuterated chloroform showed a residual caprolactam content of about 3% by weight and a mean degree of polymerization of the PA-6 block of 1.8 per branch of the star.

### Example 3

The reaction was carried out in a 7.5 liter autoclave commonly used for the melt synthesis of polyesters or polyamides.

The following were introduced via the charging lock of the reactor: 1840 g of octadecylamine (6.84 mol), 660 g of T4 (tetrakis-2,2,6,6-(β-carboxyethyl)cyclohexanone) (1.71 mol), 1.2 g of Ultranox® 236 and 2.25 g of a 50% (w/w) aqueous hypophosphorous acid solution. The autoclave was the purged by a succession of three cycles comprising evacuation and pressurization (7 bar) using dry nitrogen. After these cycles, the system was returned to atmospheric pressure and maintained under a gentle stream of dry nitrogen.

The reaction mass was mechanically stirred at 50 rpm and gradually heated from 100° C. to 150° C. over about 150 minutes. This temperature was then maintained until the end of the reaction. After maintaining these conditions for two hours, the system was gradually evacuated, to reach a pressure of 10 mbar over one hour, and then maintained under vacuum for a further one hour. Finally, the reactor was pressurized with nitrogen overpressure (7 bar) and the bottom valve was gradually opened in order to make the polymer flow onto a plate made of stainless steel coated with a Teflon film.

Differential thermal analysis (10° C./min) exhibited the presence of a melting peak at 67.0° C.

Gel permeation chromatography characterization (eluant: dichloromethane+2/1000 trifluoroacetic anhydride+0.005M tetrabutylammonium fluoroborate) showed a narrow peak corresponding to Mw=1840 g/mol and Mn=1770 g/mol (molecular weights expressed relative to polystyrene standards).

Terminal group assays showed a content of residual acid functional groups of 14.2 meq/kg and amine functional groups of 9.8 meq/kg. The degree of conversion was therefore around 99%.

¹H NMR (Bruker, 300 MHz) of a solution in a 1/1 by weight mixture of deuterated trifluoroacetic acid and deuterated chloroform showed a zero residual caprolactam content (none detected).

### Example 4

The reaction was carried out in a 7.5 liter autoclave commonly used for the melt synthesis of polyesters or polyamides.

The following were introduced via the charging lock of the reactor: 1313 g of ε-caprolactam (11.6 mol), 1389 g of octadecylamine (5.2 mol), 498 g of T4 (1.3 mol), 3.0 g of Ultranox® 236 and 5.5 g of an aqueous 50% (w/w) hypophosphorous acid solution.

The autoclave was then purged by a succession of three cycles comprising evacuation and pressurization (7 bar) using dry nitrogen. After these cycles, the system was returned to atmospheric pressure and maintained under a gentle stream of dry nitrogen.

The reaction mass was mechanically stirred at 50 rpm and gradually heated from 100° C. to 250° C. over about 250 minutes. This temperature was then maintained until the end of the reaction. After maintaining these conditions for one hour, the system was gradually evacuated in order to reach a pressure of 10 mbar over one hour, and then maintained under vacuum for a further one hour. Finally, the reactor was placed under nitrogen (7 bar) and the bottom valve gradually opened, to allow the polymer to flow onto a stainless steel plate coated with a Teflon film.

Differential thermal analysis (10° C./min) exhibited a small melting peak at 47.2° C.

Gel permeation chromatography characterization (eluant: dichloromethane+2/1000 trifluoroacetic anhydride+0.005M tetrabutylammonium fluoroborate) showed a narrow peak corresponding to Mw=4220 g/mol and Mn=3630 g/mol (the masses being expressed relative to polystyrene standards).

Terminal group assays showed a content of residual acid functional groups of 24.8 meq/kg and of amine functional groups of 5.3 meq/kg. The degree of conversion was therefore around 98%.

¹H NMR (Bruker 300 MHz) of a solution in a 1/1 by weight mixture of deuterated trifluoroacetic acid and deuterated chloroform showed a zero residual caprolactam content (none detected) and a mean degree of polymerization of the PA-6 block of 1.9 per branch of the star.

### Example 5

The reaction was carried out in a 7.5 liter autoclave commonly used for the melt synthesis of polyesters or polyamides.

The following were introduced via the charging lock of the reactor: 1467 g of ε-caprolactam (13.0 mol), 576 g of octadecylamine (2.1 mol), 206 g of T4 (0.5 mol), 3.0 g of Ultranox® 236 and 5.5 g of a 50% (w/w) aqueous hypophosphorous acid solution. The autoclave was then purged by a succession of 3 cycles comprising evacuation and pressurization (7 bar) using dry nitrogen. After these cycles, the system was returned to atmospheric pressure and maintained under a gentle stream of dry nitrogen.

The reaction mass was mechanically stirred at 50 rpm and gradually heated from 100° C. to 250° C. over about 250 minutes. This temperature was then maintained until the end of the reaction. After maintaining these conditions for one hour, the system was gradually evacuated, reaching a pressure of 10 mbar over one hour, and then maintained under vacuum for a further one hour. Finally, the reactor was pressurized with nitrogen (7 bar) and the bottom valve gradually opened, to allow the polymer to flow onto a stainless steel plate coated with a Teflon film.

Differential thermal analysis (10° C./min) showed a melting peak at 206.5° C. Gel permeation chromatography characterization (eluant: dimethylacetamide/0.1% LiBr) showed a peak corresponding to Mw=12 750 g/mol and Mn=9910 g/mol (the masses being expressed relative to polystyrene standards).

Terminal group assays showed a content of residual acid functional groups of 9.4 meq/kg and amine functional groups of 0.1 meq/kg. The degree of conversion was therefore around 98%.

¹H NMR (Bruker 300 MHz) of a solution in a 1/1 by weight mixture of deuterated trifluoroacetic acid and deuterated chloroform showed a zero residual caprolactam content (none detected) and a mean degree of polymerization of the PA-6 block of 5.3 per branch of the star.

### Example 6

The reaction was carried out in a 7.5 liter autoclave commonly used for the melt synthesis of polyesters or polyamides.

The following were introduced via the charging lock of the reactor: 1974.0 g of ε-caprolactam (17.5 mol), 533 g of benzoic acid (4.4 mol), 693 g of Jeffamine T403® from Huntsman (1.5 mol), 3.9 g of Ultranox® 236 and 7.1 g of a 50% (w/w) aqueous hypophosphorous acid solution. The autoclave was then purged by a succession of 3 cycles comprising evacuation and pressurization (7 bar) using dry nitrogen. After these cycles, the system was returned to atmospheric pressure and maintained under a gentle stream of dry nitrogen.

The reaction mass was mechanically stirred at 50 rpm and gradually heated from 100° C. to 250° C. over about 250 minutes. This temperature was then maintained until the end of the reaction. After maintaining these conditions for one hour, the system was gradually evacuated, reaching a pressure of 10 mbar over one hour, and then maintained under vacuum for a further one hour. Finally, the reactor was pressurized with nitrogen (7 bar) and the bottom valve gradually opened, to allow the polymer to flow onto a stainless steel plate coated with a Teflon film.

Differential thermal analysis (10° C./min) showed a melting peak at 181.8° C. Gel permeation chromatography characterization (eluant: dimethylacetamide/0.1% LiBr) showed a peak corresponding to Mw=4440 g/mol and Mn=2870 g/mol (the masses being expressed relative to polystyrene standards).

Terminal group assays showed a content of residual acid functional groups of 29.3 meq/kg and amine functional groups of 80.4 meq/kg. The degree of conversion was therefore around 93%.

¹H NMR (Bruker 300 MHz) of a solution in a 1/1 by weight mixture of deuterated trifluoroacetic acid and deuterated chloroform showed a zero residual caprolactam content (none detected) and a mean degree of polymerization of the PA-6 block of 2.3 per branch of the star.

### Example 7

The star additives of Examples 2 and 5 were coarsely ground and preblended in the desired proportions with granules of PA-6,6.

The PA-6,6 was defined as follows: a viscosity index, measured at 25° C. in 90% formic acid (ISO 307), of 137; an amine terminal group content of 53 meq/kg; and an acid terminal group content of 72 meq/kg.

Compositions containing 50% by weight of glass fibers (Owens Corning 123) and a PA-6,6 matrix, into which variable amounts of the star structures of Examples 2 and 5 were added, were produced by melt blending at a temperature of 280° C. in a twin-screw extruder. The PA-6,6+star additive preblend was then introduced into the twin-screw head, the glass fibers were introduced as a molten stream.

A control consisting of a thermoplastic composition based on PA-6,6 and 50% by weight of glass fibers was also prepared.

The rheological and mechanical properties of these compositions are given in Table 1.

The tests carried out were:
Spiral test ST (melt flow index) for quantifying the fluidity of the compositions according to the invention and of the control compositions:

Granules of matrix M/star composition or M control composition were melted and injected into a mold of spiral shape with a semicircular cross section, of 2 mm thickness and 4 mm diameter, in a DEMAG H200-80 molding machine with a barrel temperature of 300° C., a mold temperature of 80° C. and an injection pressure of 1500 bar. The injection time was 0.5 seconds. The result was expressed as a length of mold correctly filled with the composition. The compositions evaluated in this test all had a moisture content before molding equivalent to less than 0.1% relative to the matrix.
Mechanical tests:

The mechanical properties were evaluated by unnotched impact tests (ISO 179/1eU) and notched impact tests (ISO 179/eA).

TABLE 1
Compositions filled with 50% glass fiber (GF) with alkyl stars

| | | | | % change in | Notched | Unnotched |
|---|---|---|---|---|---|---|
| | Spiral | Moisture | MW of | MW relative | impact | impact |
| | length | content | the PA | to the | strength | strength |
| Composition | (mm) | (%)* | (g/mol)** | control MW | (KJ/m²) | (KJ/m²) |
| CONTROL PA-6,6/50% GF | 380 | 0.12 | 56 940 | 0 | 63 | 7.4 |
| PA-6,6/50% GF + 5% | 530 | 0.11 | 53 790 | −5.5 | 59 | 7 |
| star of Example 2 | | | | | | |
| PA-6,6/50% GF + 5% | 537 | 0.03 | 48 700 | −14.5 | 56 | 7 |
| star of Example 5 | | | | | | |

*Moisture content of the polyamide before molding, measured by the Karl-Fischer method;
**Maximum of the molecular weight distribution of the polyamide matrix with the star added, in polystyrene equivalents, measured by GPC with UV detection at 270 nm after carrying out the spiral fluidity test.

Measurement of the Reductions in Pack Pressure (of the Spinneret Head) when Spinning PA-6,6/Star Compositions of Examples 1 and 2

The nylon-6,6 used was one containing no titanium dioxide, with a relative viscosity of 2.5 (measured at a concentration of 10 g/l in 96% sulfuric acid). The star was incorporated into the PA-6,6 by powder blending followed by melt blending using a twin-screw extruder. The blend was then melt spun with a velocity at the first take-off point of 800 m/min, so as to obtain a continuous multifilament yarn of 90 dtex per 10 filaments.

The spinning temperature/pressure and operating conditions and the properties of the yarns obtained are given below:
spinning operation: no breakage;
spinneret pressure: 35 bar;
degree of star incorporation into the PA-6,6: 5% by weight;
twin-screw extruder heating: 285° C.;
spinneret head heating: 287° C.

The multifilament or yarn consisted of 10 strands (the spinneret having 10 holes) and the strand diameter was about 30 μm.

The reductions in pack pressure (spinneret head) were measured using a Dynisco (0-350 bar) pressure probe.

The results obtained are given in Table 2 below.

TABLE 2

| | Pack | Delta | MW of |
|---|---|---|---|
| | pressure | pressure/ | the PA* |
| Composition | (bar) | control (%) | (g/mol) |
| PA-6,6 control | 39 | 0 | 66 220 |
| PA-6,6 + 5% alkyl star of | 24 | −38.5 | 68 580 |
| Example 1 (C₁₈, | | | |
| ATC core, DP = 0) | | | |
| PA-6,6 + 5% alkyl star of | 23 | −41 | 65 380 |
| Example 2 (C₁₈, | | | |
| ATC core, DP = 2) | | | |

*maximum of the molecular weight distribution of the polyamide matrix with functionalized star polyamide added, in polystyrene equivalents, measured by GPC with UV detection at 270 nm, after spinning.

Characterization of the Behavior with Respect to Water of the PA-6,6/Star Yarn Specimens of Examples 1 and 2

This characterization was carried out by capillary imbibition of water into the multifilament consisting of 10 strands. A non-cylindrical capillary forms between the strands (typically three strands) into which water can rise with a contact angle θ between the water and the strand. This angle θ is characteristic of the hydrophilicity/hydrophobicity of the yarn surface. Principle of the measurement (ref.: A. Perwuelz, P. Mondon and C. Caze, J. Textile Res., 70(4), 333, 2000). The penetration of a liquid into a capillary network is governed by the competition between the capillary forces and the force of gravity. The capillary network was formed here between the strands of the multifilament modeled as an assembly of cylindrical capillaries having an equivalent radius R. Washburn's law applies:
h²=(Rγ cos θ/2η)t
in which:

h is the height (in m) to which the liquid has risen;

t is the time (in s);

R is the radius (in m) of the capillary;

η is the viscosity (in Pa·s) of the liquid;

γ is the surface tension (in N/m) of the liquid; and

θ is the contact angle between the liquid and the solid.

The filaments were compared with one another using the same liquid—water—for the imbibition. Therefore γ and η were the same for each specimen, as was R, by construction of the multifilaments. The cos θ values and therefore the hydrophilicity/hydrophobicity of the various multifilaments were compared using the following formula:
h²=(A cos θ)t
where A is a constant.

The multifilaments studied all consisted of 10 strands of about 30 μm. They were not sized. The yarns were conditioned at least 48 hours before the start of the experiments under controlled temperature/moisture conditions (22° C./50% relative humidity).

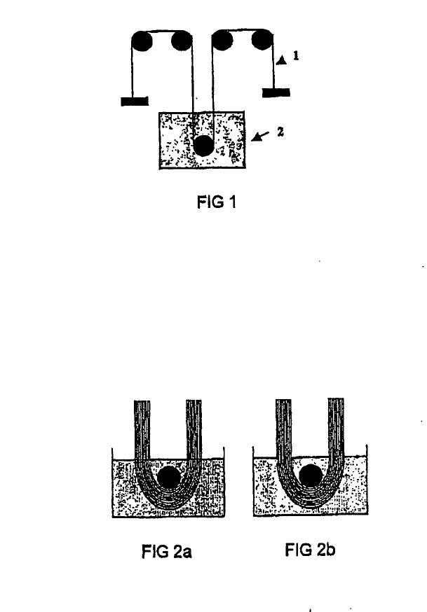

The setup used to visualize the imbibition, shown in FIG. 1, was the following: the yarn to be tested formed by a multifilament was tensioned using a system of pulleys and two 20 g masses attached at each end of the yarn. The yarn was dipped into a solution of colored water so as to visualize the imbibition. The dye chosen, which did not interact with the polyamide, was methylene blue with a concentration of 0.2%. The capillary rise was filmed by a camera connected to a video recorder and to a screen provided with a timer. The zero time in the experiment corresponded to the moment when the yarn was dipped into the colored solution (FIGS. 2a and 2b).

For all the yarns tested, a check was made that the imbibition kinetics obeyed Washburn's law for the first two minutes of the capillary rise. The regression coefficient obtained for the straight line h²=f(t) was always greater than 0.99. Consequently, the various multifilaments tested could all be modeled by an assembly of capillaries having the same radius R.

To compare them, it was then sufficient to compare the slopes of the straight line h²=f(t)

The results obtained for the control yarns and the yarns with additives, averaged over 5 to 7 experiments, are given in Table 3 below.

TABLE 3

| | Average slope and |
|---|---|
| Specimen | standard deviation (mm²/s) |
| PA-6,6 control | 8.3 ± 2.5 |
| PA-6,6 + 5% alkyl star of Example 1 | 0.3 ± 0.2 |
| PA-6,6 + 5% alkyl star of Example 2 | 0.3 ± 0.1 |

This shows that the slope of the straight line h²=f(t) is substantially smaller for the yarns containing alkyl functionalized star polyamides, which means a lower cos θ, i.e. a larger wetting angle θ. The yarns containing functionalized star polyamides are therefore more hydrophobic on the surface than the PA-6,6 control yarn.

Measurement of the Reductions in Pack Pressure (of the Spinneret Head) when Spinning Compositions Consisting of High-MW PA-6/Stars of Examples 3 to 6

The nylon-6 used was a high-MW PA-6 containing no titanium dioxide, with a relative viscosity of 4.0 (measured for a concentration of 10 g/l in 96% sulfuric acid).

The star was incorporated into the high-MW PA-6 by powder blending and then melt blending using a twin-screw extruder. The blend was then melt spun with a velocity at the first take-up point of 500 m/min, so as to obtain a multifilament continuous yarn of 220 dtex per 10 filaments.

The spinning temperature/pressure and operating conditions and the properties of the yarns obtained are given below:
spinning operation: no breakage;
spinneret pressure: 35 bar;
twin-screw extruder heating: 315° C.;
spinneret head heating: 296° C.

The multifilament or yarn consisted of 10 strands (the spinneret having 10 holes) and the strand diameter was about 50 μm.

The reductions in pack pressure (spinneret head) were measured using a Dynisco (0-350 bar) pressure probe.

The results obtained are given in Table 4 below.

TABLE 4

| | Pack | Delta | MW of |
|---|---|---|---|
| | pressure | pressure/ | the PA* |
| Composition | (bar) | control (%) | (g/mol) |
| Control high-MW PA-6 | 66 | 0 | 80 530 |
| High-MW PA-6 + 5% alkyl star | 34 | −48.5 | 80 750 |
| of Example 3 | | | |
| High-MW PA-6 + 5% alkyl star | 44 | −33.3 | 81 850 |
| of Example 4 | | | |
| High-MW PA-6 + 3.5% alkyl star | 50 | −24 | 76 460 |
| of Example 5 | | | |
| High-MW PA-6 + 3.5% hydrophilic | 33 | −50 | 67 360 |
| star of Example 6 | | | |

*maximum of the molecular weight distribution of the polyamide matrix with functionalized star polyamide added, in polystyrene equivalents, measured by GPC with UV detection at 270 nm, after spinning.

Characterization of the Behavior with Respect to Water of Yarn Specimens Consisting of High-MW PA-6/Stars of Examples 3 to 5

This characterization was performed by capillary imbibition of water into multifilaments consisting of 10 strands, according to the same protocol as mentioned above.

The results obtained for the control yarns and the yarns with additive, averaged over, 3 to 5 experiments, are given in Table 5 below.

TABLE 5

| | Average slope and |
|---|---|
| Specimen | standard deviation (mm²/s) |
| Control high-MW PA-6 | 20.9 ± 12.3 |
| High-MW PA-6 + 5% alkyl star of | 0 (no capillary |
| Example 3 | rise detectable) |
| High-MW PA-6 + 5% alkyl star of | 0.007 ± 0.002 |
| Example 4 | |
| High-MW PA-6 + 5% alkyl star of | 4.1 ± 1.9 |
| Example 5 | |

It may be seen that the slope of the straight line h²=f(t) is substantially smaller for the yarns containing alkyl functionalized star polyamides, which means a lower cos θ, i.e. a larger wetting angle θ. The yarns containing alkyl functionalized star polyamides are therefore more hydrophobic on the surface than the high-MW PA-6 control yarn.

1-25. (canceled)

26. A composition comprising at least one polymer matrix and at least one additive, said additive being obtained by the reaction of a blend of compounds, comprising:
a) a polyfunctional compound of formula (I):
R¹-Xₙ (I)
b) optionally, a difunctional monomer of formula (II) or the corresponding cyclic form:
X—R²—Y (II)
c) a monofunctional compound of formula (III):
R³—Y (III)
wherein:
R¹ represents a hydrocarbon radical and/or silicone;
R² represents a hydrocarbon radical;
X and Y are antagonistic reactive functional groups capable of reacting together to form a covalent bond;
n is between 3 and 50; and
R³ represents an aliphatic, cycloaliphatic, aromatic hydrocarbon radical, or a silicone radical, optionally said radical R³ having one or more heteroatoms, with the exception of polyalkylene oxides.

27. The composition as claimed in claim 26, wherein Y is an amine functional group when X represents a carboxylic functional group, or Y is a carboxylic functional group when X represents an amine functional group.

28. The composition as claimed in claim 26, wherein the polyfunctional compound of general formula (I) is: 2,2,6,6-tetra(β-carboxyethyl)cyclohexanone, diaminopropane-N,N,N′,N′-tetraacetic acid, nitrilotrialkylamines, trialkylenetetramines, tetraalkylenepentamines, 4-aminoethyl-1,8-octanediamine, 3,5,3′,5′biphenyltetracarboxylic acid, acids from phthalocyanine, acids from naphthalocyanine, 3,5,3′,5′-biphenyltetracarboxylic acid, 1,3,5,7-naphthalene-tetracarboxylic acid, 2,4,6-pyridinetricarboxylic acid, 3,5,3′,5′-bipyridyltetracarboxylic acid, 3,5,3′,5′benzophenonetetracarboxylic acid, 1,3,6,8-acridinetetracarboxylic acid, trimesic acid, 1,2,4,5benzenetetracarboxylic acid, 1,3,5-triazines, 1,4diazines, melamine, 2,3,5,6tetraethylpiperazine compounds, 1,4-piperazines, tetrathiafulvalenes, 2,4,6-tri(aminocaproic acid)1,3,5-triazine (TACT), or polyalkylene oxides.

29. The composition as claimed in claim 26, wherein the difunctional compound of general formula (II) is ε-caprolactam, aminocaproic acid, p-aminobenzoic acid, m-aminobenzoic acid, 11-aminoundecanoic acid, lauryllactam, 12-aminododecanoic acid, caprolactone, 6-hydroxy hexanoic acid, or oligomers thereof.

30. The composition as claimed in claim 26, wherein the monofunctional compound of general formula (III) is a monoacid aliphatic compound; a monoamine aliphatic compound, a monoamine aromatic compound, a monoacid aromatic compound, a monoamine silicone oil, a monoacid silicone oil, a monoamine organophosphorus compound, a monocarboxylic acid organophosphorus compound; a monoamine organosulfone compound, a monocarboxylic acid organosulfone compound; a monoamine quaternary ammonium compound, or a monocarboxylic acid quaternary ammonium compound.

31. The composition as claimed in claim 30, wherein the monofunctional compound of general formula (III) is: n-hexadecylamine, n-octadecylamine, n-dodecylamine, benzylamine, polydimethylsiloxane monopropylamine, aminomethylphosphonic acid, sufanilic acid, sulfobenzoic acid, or betaine.

32. The composition as claimed in claim 26, wherein the additive possesses an overall degree of polymerization of between 0 and 200.

33. The composition as claimed in claim 26, wherein the additive possesses a molecular weight of between 500 and 20 000 g/mol.

34. The composition as claimed in claim 26, wherein the additive has an acid or amine terminal group content of between 0 and 100 meq/kg.

35. The composition as claimed in claim 26, wherein the additive is obtained by the reaction of a blend of compounds comprising at least: from 1 to 60% by weight of polyfunctional compound of formula (I), from 0 to 95% by weight of difunctional monomer of formula (II) and from 3 to 90% by weight of monofunctional compound of formula (III).

36. The composition as claimed in claim 35, wherein the additive is obtained by the reaction of a blend of compounds comprising at least: from 5 to 20% by weight of polyfunctional compound of formula (I), from 20 to 80% by weight of difunctional monomer of formula (II) and from 10 to 70% by weight of monofunctional compound of formula (III).

37. The composition as claimed in claim 26, wherein the polymer matrix is composed of: polypropylene, polyethylene terephthalate (PET), polybutylene terephthalate (PBT), polypropylene terephthalate (PPT), (meth)acrylate-butadiene-styrene copolymer (ABS), polyacetal (POM), polyamides, semiaromatic polyamides, such as polyphthalamide (AMODEL) or polyarylamide (IXEF), polypropylene oxide (PPO), polyvinyl chloride (PVC), or copolymers thereof.

38. The composition as claimed in claim 26, wherein the matrix is composed of nylon-6, nylon-6,6, nylon-4, nylon-11, nylon-12, nylon-4/6, nylon-6/10, nylon-6/12, nylon-6/36, nylon-12/12 or copolymers thereof.

39. The composition as claimed in claim 26, wherein the polymer matrix contains from 0.1 to 20% by weight of additive relative to the total weight of said matrix.

40. The composition as claimed in claim 39, wherein the polymer matrix contains from 1 to 10% by weight of additive relative to the total weight of said matrix.

41. A process for producing a composition as claimed in claim 26, comprising the step of blending the additive with the polymer matrix.

42. The process for producing a composition as claimed in claim 41, wherein the step of blending the additive, is carried out before or during polymerization.

43. The process for producing a composition as claimed in claim 41, comprising the step of blending a mixture of an additive concentrate in a polymer matrix, into the polymer matrix.

44. An article made of a composition as claimed in claim 26.

45. The article of claim 44, being a yarn, a fiber, a film, a filament or a molded article.

46. A process for modifying the Theological behavior of a polymer matrix, comprising the step of adding to said matrix an efficient amount of an additive obtained by the reaction of a blend of compounds, comprising:
a) a polyfunctional compound of formula (I):
R¹-Xₙ (I)
b) optionally, a difunctional monomer of formula (II) or the corresponding cyclic form:
X—R²—Y (II)
c) a monofunctional compound of formula (III):
R³—Y (III)
wherein:
wherein:
R¹ represents a hydrocarbon radical and/or silicone;
R² represents a hydrocarbon radical;
X and Y are antagonistic reactive functional groups capable of reacting together to form a covalent bond;
n is between 3 and 50; and
R³ represents an aliphatic, cycloaliphatic, aromatic hydrocarbon radical or silicone radical, optionally said radical R³ having one or more heteroatoms.

47. The process as defined in claim 46, wherein:
R¹ represents a hydrocarbon radical and/or silicone;
R² represents a hydrocarbon radical;
X and Y are antagonistic reactive functional groups capable of reacting together to form a covalent bond;
n is between 3 and 50; and
R³ represents a hydrophobic aliphatic, cycloaliphatic, aromatic hydrocarbon radical, or silicone radical, optionally said radical R³ having one or more heteroatoms.

48. The process as claimed in claim 47, wherein the monofunctional compound of formula (III) is a monoacid compound, a monoamine aliphatic compound, a monoamine compound, a monoacid aromatic compound, a monoamine silicone oil, or a monoacid silicone oil.

49. The process as defined in claim 46, wherein:
R¹ represents a hydrocarbon radical and/or silicone;
R² represents a hydrocarbon radical;
X and Y are antagonistic reactive functional groups capable of reacting together to form a covalent bond;
n is between 3 and 50; and
R³ represents a hydrophilic aliphatic, cycloaliphatic, or aromatic hydrocarbon radicaloptionally said radical R³ havinge one or more heteroatoms, a phosphonic group, phosphoric group, sulfonic group, or quaternary ammonium functional group, with the exception of polyalkylene oxides;
in order to modify the hydrophilic behavior of a polymer matrix.

50. The process as defined in claim 49, wherein: the monofunctional compound of formula (III) is: a monoamine organophosphorous compound, a monocarboxylic acid organophosphorous compound, a monoamine organosulfone compound, a monocarboxylic acid organosulfone compound, a monoamine quaternary ammonium compound, or a monocarboxylic acid quaternary ammonium compound.
